(19) United States
(12) Patent Application Publication
(10) Pub. No.: US 2024/0161550 A1
(43) Pub. Date: May 16, 2024

(54) SHARED PARKING DETECTION AND OPTIMIZATION

(71) Applicant: TOYOTA MOTOR ENGINEERING & MANUFACTURING NORTH AMERICA, INC., PLANO, TX (US)

(72) Inventors: TAKAMASA HIGUCHI, Mountain View, CA (US); Kentaro Oguchi, Mountain View, CA (US)

(73) Assignees: TOYOTA MOTOR ENGINEERING & MANUFACTURING NORTH AMERICA, INC., PLANO, TX (US); TOYOTA JIDOSHA KABUSHIKI KAISHA, TOYOTA-SHI (JP)

(21) Appl. No.: 17/988,699

(22) Filed: Nov. 16, 2022

(51) Int. Cl. G07B 15/02; G06Q 10/02; G06Q 30/06

(52) U.S. Cl. CPC G07B 15/02; G06Q 10/02; G06Q 30/0645

(57) ABSTRACT

Systems and methods are provided for determining parking spaces to rent to the public. The systems and methods can determine a plurality of time bins and receive data on the occupancy of parking spaces for each time bin. A determined number of reserved spaces can be calculated for each time bin. Restrictions associated with the parking space can also be determined. A final number of parking spaces to rent can be determined based on the determined number of reserved spaces and the restrictions.

### TECHNICAL FIELD

The present disclosure relates generally to systems and methods for renting parking spaces to members of the public, and in particular, some implementations may relate to determining what parking spaces of a parking facility to make available for rent to members of the public.

### DESCRIPTION OF RELATED ART

Parking facilities such as parking garages, parking lots or other multi-space parking facilities can experience various levels of occupancy throughout the day based on the location and/or purpose of the parking facility. For example, a garage at an office building may experience low occupancy during the weekend due to no employees working at the building. During the weekend, the associated parking garage may rent parking spaces to the general public for the weekend only. These parking garages may face difficulty in determining what spaces to make available for rent due to the high variability of occupancy.

### BRIEF SUMMARY OF THE DISCLOSURE

According to various embodiments of the disclosed technology, a method can comprise determining a plurality of time bins associated with a plurality of reserved spaces; receiving data on a plurality of unoccupied parking spaces of the plurality of reserved parking spaces for each time bin of the plurality of time bins; for each time bin, calculating a determined number of the reserved spaces to offer for rent to non-tenants of the plurality of parking spaces; determining one or more restrictions associated with the plurality of reserved parking spaces; based on the determined number of the reserved spaces to offer for rent and the one or more restrictions, determining a final number of parking spaces to offer for rent for each time bin; and offering a group of parking spaces to non-tenants.

In some embodiments, the data on the plurality of unoccupied parking spaces comprises at least one of parking spot sensor data, vehicle sensor data, traffic data, infrastructure data, and occupancy data.

In some embodiments, calculating the determined number of spaces to rent comprises: calculating a percentage of time duration for which the number of open parking spaces is lower than a first threshold; comparing the percentage of time duration to a second threshold; and if the percentage of time duration is less than the second threshold, determining that the first threshold of open parking spaces may be rented to non-tenants.

In some embodiments, the method further comprises decreasing the first threshold if the percentage of time duration is higher than the second threshold.

In some embodiments, the method further comprises increasing the first threshold if the percentage of time duration is lower than the second threshold.

In some embodiments, the one or more restrictions comprises at least one of municipal parking restrictions and selected parking restrictions.

In some embodiments, offering the group of parking spaces comprises selecting a subset plurality of parking spaces close to an exit or entrance.

In some embodiments, offering the group of parking spaces comprises selecting a subset plurality of parking spaces with an occupancy rate below an occupancy threshold.

In some embodiments, the method further comprises displaying information on the spaces offered for rent in a vehicle within a threshold distance of the plurality of parking spaces.

In some embodiments, the vehicle within a threshold distance of the plurality of parking spaces communicates the information to one or more additional vehicles through a vehicle-connected network.

In some embodiments, the method further comprises transmitting information on the spaces offered for rent to an external database.

In some embodiments, determining a plurality of time bins comprises receiving occupancy data on the plurality of parking spaces for a plurality of time periods and determining time bins by grouping time periods with similar occupancy data.

In some embodiments, determining a plurality of time bins is based on operating hours for one or more organizations associated with the plurality of parking spaces.

In some embodiments, calculating a determined number of the reserved spaces to offer for rent is based on renting the reserved spaces for one or more successive time bins.

According to various embodiments of the disclosed technology, a system can comprise: a processor; and a memory coupled to the processor to store instructions, which when executed by the processor, cause the processor to: determine a plurality of time bins associated with a plurality of parking spaces; receive data on a plurality of unoccupied parking spaces of the plurality of parking spaces for each time bin of the plurality of time bins; calculate a percentage of time duration for which the number of open parking spaces is lower than a first threshold; compare the percentage of time duration to a second threshold; if the percentage of time duration is less than the second threshold, determining that the first threshold of open parking spaces may be rented to non-tenants; determine one or more restrictions associated with the plurality of parking spaces; based on the first threshold of open parking spaces and the one or more restrictions, determine a final number of parking spaces to rent for each time bin; and designate a group of parking spaces of the plurality of parking spaces as renting spaces.

In some embodiments, the data on the plurality of unoccupied parking spaces comprises at least one of parking spot sensor data, vehicle image data, traffic data, infrastructure data, and occupancy data.

In some embodiments, the processor is further configured to decrease the first threshold if the percentage of time duration is higher than the second threshold.

In some embodiments, the processor is further configured to repeat all steps until the percentage of time duration is less than the second threshold.

In some embodiments, the one or more restrictions comprises at least one of municipal parking restrictions and selected parking restrictions.

In some embodiments, the processor is further configured to select a subset plurality of parking spaces close to an exit or entrance as renting spaces.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following FIGURES. The FIGURES are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example architecture for public parking space detection in accordance with one embodiment of the systems and methods described herein.

FIG. 3 illustrates an example system for receiving data in accordance with some embodiments.

FIG. 4 illustrates an example system for determining public parking spaces in accordance with one embodiment.

FIG. 5 illustrates an example method in accordance with some embodiments.

FIG. 6 is an example computing component that may be used to implement various features of embodiments described in the present disclosure.

The FIGURES are not exhaustive and do not limit the present disclosure to the precise form disclosed.

### DETAILED DESCRIPTION

Embodiments of the systems and methods disclosed herein may be configured to determine a quantity of parking spaces in a parking facility to make available for rent to the public. Parking facilities often have regular tenants who use parking spots in the facility. Depending on the facility, some or all of the regular tenants may not occupy the spaces 24 hours a day, 7 days a week. For example, for parking facilities associated with an office space, regular tenants may tend to park more predominantly during working hours and much less so after hours or on the weekends. Consequently, the capacity of the lot may vary dramatically, from quite full during the work day and much less full (if not practically empty) after hours, overnight and during the weekends. Accordingly, these high levels of vacancy create opportunities for additional revenue for the parking facility and may help to alleviate parking congestion in nearby parts of the city or other geographic region in which they are located.

Parking facilities and metropolitan regions may benefit from converting at least portions of these parking facilities from private to shared or public parking during certain times of the day. For example, it may be desirable to have parking spaces available to the general public on weekends and holidays to accommodate drivers who have come to the area for shopping, dining, concerts, sporting events and so on.

Accordingly, systems and methods may be provided to enable parking facilities (e.g. parking facility managers) to make a percentage of their otherwise private spaces available to the general public based on capacity and occupancy of the garage at various times. The systems and methods may be further configured to ensure that parking facilities do not make too many private spaces available to the general public, so that regular occupants are not prevented from using parking spaces. In some implementations, the methods and systems disclosed herein can determine an optimal number of spaces to rent to the public based on various parameters including various types of data, occupancy, and restrictions associated with renting to the public.

The systems and methods disclosed herein can determine a plurality of time bins associated with the parking spaces. For example, the time bins can be defined based on parking characteristics of the particular facility. For example, time bins for an office space might be divided into a time bin for working hours (e.g., Monday-Friday 8 AM-5 PM), a time bin for work day evening hours (e.g., Monday-Friday 5 PM-9 PM) an overnight time bin (e.g., Sunday-Thursday 9 PM at night until 8 AM the next morning) and a bin for weekend hours (e.g., Friday 9 PM-Sunday 9 PM). As another example, retail facilities may have one bin for shopping hours, one or more bins for employee open and closing time (e.g., an hour before and an hour after the retail shops are open for business), and a bin for all other hours. As these examples illustrate, the bins can be created based on the time periods during which occupancy may be fairly consistent for that bin, and different from occupancy of other bids. Additionally, the bins may be defined differently for different types of facilities or for parking facilities at different locations. For example, parking facilities at work locations may have peak occupancy during weekday work hours, while parking facilities at shopping complexes may have different periods of peak occupancy.

The predicted nominal occupancies can be determined for each of the time bins, and the time bins can each be associated with these occupancies. For example, the time bin during weekday work hours for an office parking facility may be a peak occupancy level for that parking facility and may have an occupancy rate, for example, of 95%. The time bin for that office parking facility for weekday evening hours may be lower and may only need to accommodate tenants who remain late at work. Accordingly, that time bin for the parking facility may have an occupancy rate, for example, of 30%. For overnight parking, the parking facility at the office may only need to accommodate very few tenants, and its occupancy rate for that time bin might be, for example, 5%. The occupancies can be determined based on actual historic parking data, and the occupancies can change over time as tenant behaviors change. Tenant ingress and egress data (e.g., collected based on their parking pass usage) can be used to determine occupancy rates during particular times of the day. Other data indicating occupancy of parking spaces for each time bin can also be used. This data may be generated, for example, by a connected vehicle, by parking sensor data, by municipal data, or other infrastructure data. This actual occupancy data may also be used to determine the bins. For example, a time period during which a consistent occupancy level is detected may define a bin. A determined number of spaces to rent can be calculated for each time bin.

Based on the occupancies, the systems and methods may determine an optimal number of spaces to make available for rent for each time bin. The time a space may be available to rent may comprise one or more successive time bins. For example, the system may take a quantity of unoccupied spaces for each bin, and make those available for parking by the general public for the duration of the time bin. A cushion may be provided (built into the predicted occupancy or otherwise) so that regular tenants are not subjected to unavailability of spaces. Thus, the system may be configured to determine a determined number of spaces to make available for each bin.

Restrictions associated with the parking space can also be determined. These restrictions can reduce the number of spaces to rent based on incentives or other optional mitigations. This can include municipal incentives, traffic data, or other infrastructure data. A final number of parking spaces to rent can be determined based on the determined number of spaces determined and the restrictions. The group of parking spaces to rent can be designated based on the final number of parking spaces, the use of particular parking spaces, or other locational recommendations for placing public parking spaces.

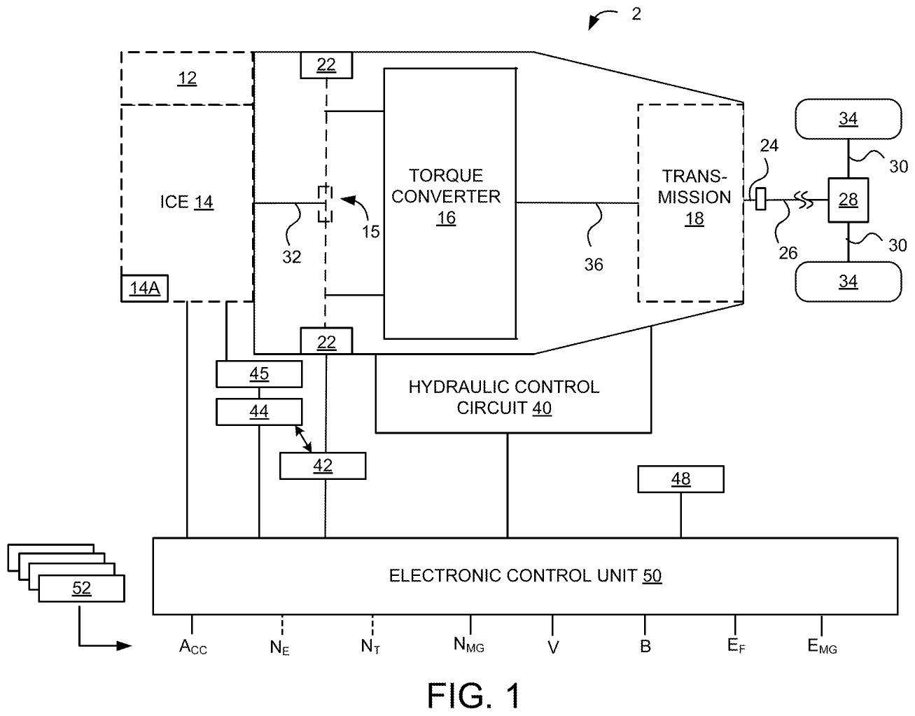

The systems and methods disclosed herein may be implemented with any of a number of different vehicles and vehicle types. For example, the systems and methods disclosed herein may be used with automobiles, trucks, motorcycles, recreational vehicles and other like on-or off-road vehicles. In addition, the principles disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for detecting and determining public parking spaces can be implemented in other types of vehicle including gasoline- or diesel-powered vehicles, fuel-cell vehicles, electric vehicles, or other vehicles.

FIG. 1 illustrates a drive system of a vehicle 100 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, vehicle 100 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 100 relies on the motive force generated at least by internal combustion engine 14, and a clutch 15 may be included to engage engine 14. In the EV travel mode, vehicle 100 is powered by the motive force generated by motor(s) 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 100 and is powered electrically via a battery 44. Battery 44 may be implemented as one or more batteries or other power storage devices including, for example, lead-acid batteries, nickel-metal hydride batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch 15 can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 100 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in vehicle 100. For example, electronic control unit 50 may receive signals that indicate vehicle operating conditions or characteristics, or signals that can be used to derive vehicle operating conditions or characteristics. These may include, but are not limited to accelerator operation amount, A_{CC}, a revolution speed, N_{E}, of internal combustion engine 14 (engine RPM), a rotational speed, N_{MG}, of the motor 22 (motor rotational speed), and vehicle speed, N_{V}. These may also include torque converter 16 output, N_{T} (e.g., output amps indicative of motor output), brake operation amount/pressure, B, battery SOC (i.e., the charged amount for battery 44 detected by an SOC sensor). Accordingly, vehicle 100 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, E_{F}, motor efficiency, E_{MG}, hybrid (internal combustion engine 14+MG 12) efficiency, acceleration, A_{CC}, gap detection, etc.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as one example of vehicle systems with which embodiments of the disclosed technology may be implemented. One of ordinary skill in the art reading this description will understand how the disclosed embodiments can be implemented with this and other vehicle platforms.

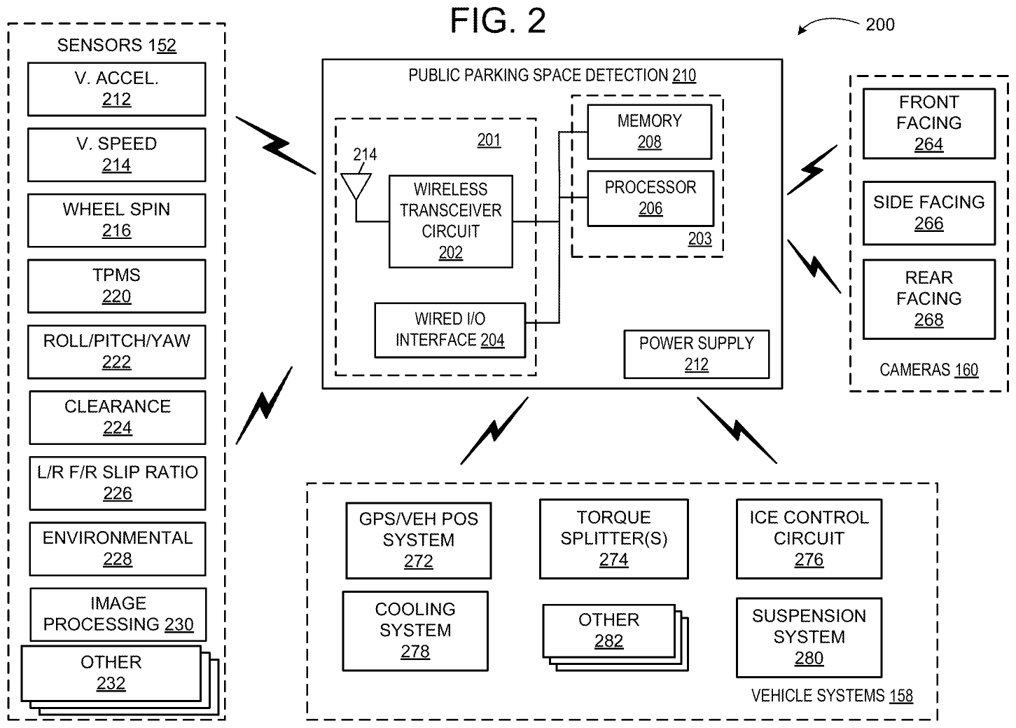

FIG. 2 illustrates an example vehicle system for detecting rentable public parking spaces in accordance with one embodiment of the systems and methods described herein. In this example, system 200 includes a public parking space detection circuit 210, a plurality of sensors 152 and a plurality of vehicle systems 158. Sensors 152 and vehicle systems 158 can communicate with public parking space detection circuit 210 via a wired or wireless communication interface. Although sensors 152 and vehicle systems 158 are depicted as communicating with public parking space detection circuit 210, they can also communicate with each other as well as with other vehicle systems. Public parking space detection circuit 210 can be implemented as an ECU or as part of an ECU such as, for example electronic control unit 50. In other embodiments, public parking space detection circuit 210 can be implemented independently of the ECU.

Public parking space detection circuit 210 includes a communication circuit 201, a processor 206, a memory 208, and a power supply 211. Components of public parking space detection circuit 210 are illustrated as communicating with each other via a data bus, although other communication in interfaces can be included.

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store the calibration parameters, images (analysis or historic), point parameters, instructions and variables for processor 206 as well as any other suitable information. Memory 208 can be made up of one or more modules of one or more different types of memory, and may be configured to store data and other information as well as operational instructions that may be used by the processor 206 to initiate public parking space detection circuit 210.

Although the example of FIG. 2 is illustrated using processor 206 and memory 208, as described below with reference to circuits disclosed herein, decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up a public parking space detection circuit 210.

Communication circuit 201 either or both a wireless transceiver circuit 202 with an associated antenna 213 and a wired I/O interface 204 with an associated hardwired data port (not illustrated). As this example illustrates, communications with public parking space detection circuit 210 can include either or both wired and wireless communications circuits 201. Wireless transceiver circuit 202 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 213 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by public parking space detection circuit 210 to/from other entities such as sensors 152 and vehicle systems 158.

Wired I/O interface 204 can include a transmitter and a receiver (not shown) for hardwired communications with other devices. For example, wired I/O interface 204 can provide a hardwired interface to other components, including sensors 152 and vehicle systems 158. Wired I/O interface 204 can communicate with other devices using Ethernet or any of a number of other wired communication protocols whether standardized, proprietary, open, point-to-point, networked or otherwise.

Power supply 211 can include one or more of a battery or batteries (such as, e.g., Li-ion, Li-Polymer, NiMH, NiCd, NiZn, and NiH₂, to name a few, whether rechargeable or primary batteries), a power connector (e.g., to connect to vehicle supplied power, etc.), an energy harvester (e.g., solar cells, piezoelectric system, etc.), or it can include any other suitable power supply.

Sensors 152 can include, for example, sensors 52 such as those described above with reference to the example of FIG. 1. Sensors 152 can include additional sensors that may or may not otherwise be included on a standard vehicle (e.g. vehicle 100) with which the system 200 is implemented. In the illustrated example, sensors 152 include vehicle acceleration sensors 212, vehicle speed sensors 214, wheelspin sensors 216 (e.g., one for each wheel), a tire pressure monitoring system (TPMS) 220, accelerometers such as a 3-axis accelerometer 222 to detect roll, pitch and yaw of the vehicle, vehicle clearance sensors 224, left-right and front-rear slip ratio sensors 226, environmental sensors 228 (e.g., to detect salinity or other environmental conditions), and image processing sensors 230 (e.g. to detect the presence of vehicles in a parking spot and labels associated with a parking spot). Image processing sensors can communicate with cameras 16 to receive images captured by front facing cameras 264, side facing cameras 266, and/or rear facing camera 268. Additional sensors 232 can also be included as may be appropriate for a given implementation of system 200.

Vehicle systems 158 can include any of a number of different vehicle components or subsystems used to control or monitor various aspects of the vehicle and its performance. In this example, the vehicle systems 158 include a GPS or other vehicle positioning system 272; torque splitters 274 that can control distribution of power among the vehicle wheels such as, for example, by controlling front/rear and left/right torque split; engine control circuits 276 to control the operation of engine (e.g. Internal combustion engine 14); cooling systems 278 to provide cooling for the motors, power electronics, the engine, or other vehicle systems; suspension system 280 such as, for example, an adjustable-height air suspension system, or an adjustable-damping suspension system; and other vehicle systems 282.

Communication circuit 201 can be used to transmit and receive information between public parking space detection circuit 210 and sensors 152, and public parking space detection circuit 210 and vehicle systems 158. Also, sensors 152 may communicate with vehicle systems 158 directly or indirectly (e.g., via communication circuit 201 or otherwise).

In various embodiments, communication circuit 201 can be configured to receive data and other information from sensors 152 that is used in determining public parking spaces. Additionally, communication circuit 201 can be used to send an activation signal or other activation information to various vehicle systems 158 as part of entering the detection mode. For example, as described in more detail below, communication circuit 201 can be used to send signals to one or more of: torque splitters 274 to control front/rear torque split and left/right torque split; motor controllers 276 to, for example, control motor torque, motor speed of the various motors in the system; ICE control circuit 276 to, for example, control power to engine 14 (e.g., to shut down the engine so all power goes to the rear motors, to ensure the engine is running to charge the batteries or allow more power to flow to the motors); cooling system (e.g., 278 to increase cooling system flow for one or more motors and their associated electronics); suspension system 280 (e.g., to increase ground clearance such as by increasing the ride height using the air suspension). The decision regarding what action to take via these various vehicle systems 158 can be made based on the information detected by sensors 152. Examples of this are described in more detail below.

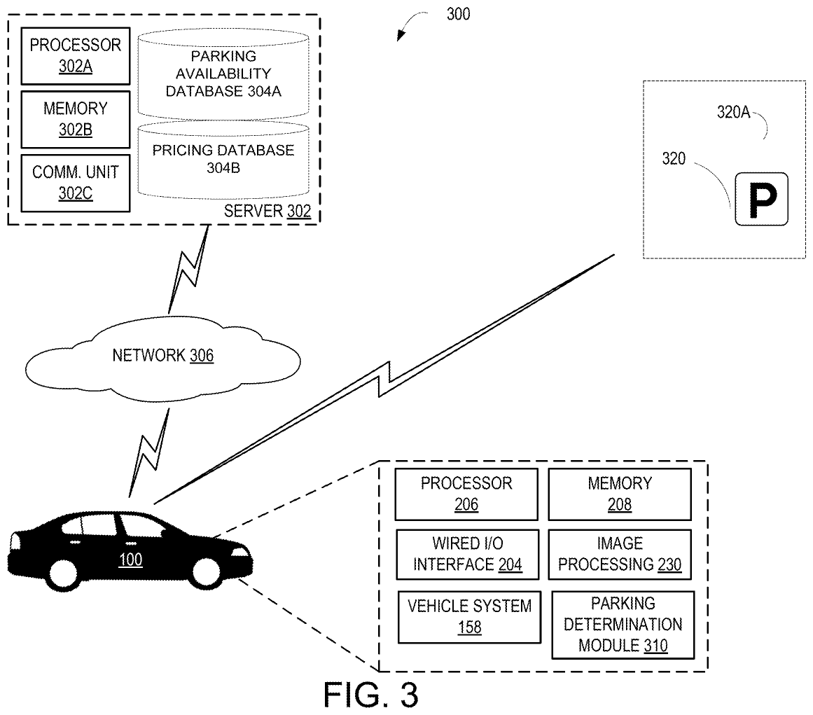

FIG. 3 illustrates an example system 300 and component parts of the system 300 for detecting rentable parking spaces. System 300 includes a server 302, vehicle 100, and a network 306 over which vehicle 100 may communicate with server 302. It should be noted that in this embodiment, vehicle 100 may be collecting data by traversing a parking garage roadways, the collected data including images of parking spaces and any associated labels for the parking spaces. It should be understood that system 300 is an example, and system 300 in addition to other systems contemplated in accordance with the present disclosure may include additional or fewer components, may combine components, and/or divide one or more of the components into additional components, etc. For example, system 300 may include any number of vehicles and servers.

Network 306 can be a conventional type of communication network that is wired or wireless, and may have numerous different configurations including a star configuration, token ring configuration, or other configurations. Furthermore, the network 306 may include one or more local area networks (LAN), wide area networks (WAN) (e.g., the Internet), public networks, private networks, virtual networks, peer-to-peer networks, and/or other interconnected data paths across which multiple devices may communicate. For instance, the network 306 may include a vehicle-to-vehicle (V2V) network, a vehicle-to-infrastructure/infrastructure-to-vehicle network (V2I), etc.

The network 306 may also be coupled to or include portions of a telecommunications network for sending data in a variety of different communication protocols. In some embodiments, the network 306 includes Bluetooth communication networks or a cellular communications network for sending and receiving data including via short messaging service (SMS), multimedia messaging service (MMS), hypertext transfer protocol (HTTP), direct data connection, WAP, email, etc. In some embodiments, the network 306 is a wireless network using a connection such as DSRC, WAVE, 802.11p, a 3G, 4G, 5G+ network, WiFi™, or any other wireless networks. Although FIG. 3A illustrates a single block for the network 306 that couples to the server 302 and to vehicle 100, it should be understood that the network 306 may in practice, comprise any number of combination of networks, as noted above.

The server 302 can include a hardware and/or virtual server that includes a processor 302A, a memory 302B, and network communication capabilities (e.g., a communication unit 302C). The server 302 may be communicatively coupled to the network 306. In some embodiments, the server 302 can send and receive data to and from vehicle 100 (as well as other servers, data repositories, and the like). The server 302 may include an instance of a parking availability database 304A that may include data related to the parking availability for a particular parking garage. Server 302 may also include an instance of pricing database 304B that includes pricing information related to parking spaces based on the geographic location or other parameters associated with the parking area.

In FIG. 3, the server 302 is shown as including databases 304A and 304B, however it should be understood that vehicle 100 and/or another component of the system 300, may additionally and/or alternatively store or cache parking availability and/or pricing data. For instance, vehicle 100 may include an instance of databases 304A and 304B, may cache data from databases 304A and 304B, etc. For instance, the data may be pre-stored/installed in vehicle 100, stored and/or refreshed upon setup or first use, replicated at various intervals, updated upon identification of a scenario resulting in incorrect/inconsistent parking detection, etc. In further embodiments, data from databases 304A and 304B may be requested/downloaded at runtime. Other suitable variations are also possible and contemplated.

Vehicle 100 includes a processor 206, a memory 208, a wired I/O interface 204, (e.g., as described above in FIG. 2) and a parking determination module 310 (described in greater detail below). Processor 206 may be any suitable processor, which is coupled to other components of vehicle 100, such as one or more sensors, actuators, motivators, etc. Vehicle 100 may send and receive data to and from server 302. Memory 208 of vehicle 100 may capture image data using image processing sensors 230 or other sensors 152 which can be processed by parking determination module 310.

Regarding the V2I information, FIG. 3 illustrates parking space 320 as being operatively connected to a V2I component or element 320A that allows parking space 320 to communicate parking availability, (e.g. whether the space is available, whether the space is available to the public, etc.) to connected vehicles, e.g., V2I/V2V/V2X-capable vehicles. That is, V2I component 320A may transmit information regarding the parking space 320's availability. That is, although not illustrated, similar to vehicle 100, V2I component 320A may comprise at least a controller/processor, memory, and communications unit. The controller/processor may handle receipt of/capturing, in this case, parking availability data, processing the data as needed, storing/caching the data in memory, and conveying the data to vehicle 100.

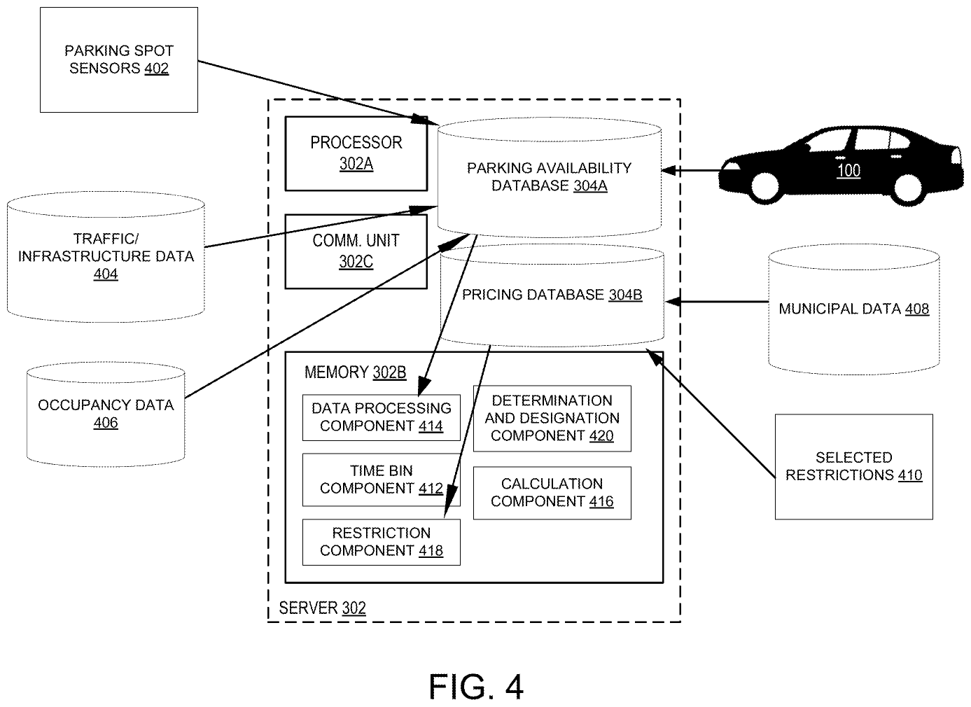

FIG. 4 illustrates an example system for determining a quantity of parking spaces or specific parking spaces to rent to the public. As further described below, the determination may comprise designating a block of parking spaces or specific parking spaces with a low occupancy rate to designate for the public. As described above, parking availability database 304A can receive data on the availability of reserved parking spaces in an area of interest. Reserved spaces may comprise parking spaces assigned to a particular tenant, a particular location of one or more parking spaces, or a group of parking spaces designated for tenant use. This data may comprise determinations from vehicle 100 that a parking space is available using image processing as described above. Other sources of data may comprise parking spot sensors 402 (i.e. sensors that denote a parking space is available), traffic/infrastructure data 404 (data on the parking garage, general availability of parking in the city, traffic congestion suggesting a high occupancy is imminent, etc.), and occupancy data 406 (e.g. historical occupancy data for the parking area, real-time occupancy if parking spot sensors are present, etc.). Alternatively, ingress/egress data for a parking facility may be used to determine occupancy. For example, employees may scan into a parking garage using a keycard, while members of the public take a ticket to enter the parking garage. Using ingress/egress data, data may differentiate between private occupancy and public occupancy. Pricing database 304B also receive data from any of the above sources. Other sources of data may include municipal data 408 (including regulations on parking incentives or restrictions) and restrictions specific to the parking area 410 such as the owner's desired occupancy level, owner's desired public occupancy, etc. As described above, databases 304A and 304B may be external to server 302. Databases 304A and 304B can transmit this received data to memory 302B to activate various components of 302B as described below.

Memory 302B can activate components 412-420 to determine a number of parking spaces to rent to the public. Time bin component 412 can define a plurality of time bins to allocate parking spaces. For example, a time bin may exist from 12 am to 1 am, 1 am to 2 am, and so on. The time bins may comprise equal increments or may be divided based on portions of the day. As an example, a time bin may exist for the hours associated with morning traffic, a time bin may follow for the general work day, followed by a time bin associated with evening traffic. Time bins may also be associated with full days, weekdays and weekends, or any combination of the above. Time bins may be determined based on the operating hours for the garage or surrounding businesses. Alternatively, time bins can be formed by grouping time periods with similar occupancies so that the time bin has a consistent occupancy. Each time bin can be used to calculate a number of parking spaces to rent to the public during that specific time bin. For example, 10 spaces may be rented out from 8 am to 5 pm, and 30 spaces may be rented out from 5 pm to 7 pm.

Data processing component 414 can receive data from parking availability database 304A. As described above, parking availability database 304A can transmit data from sources 402-410 to determine the occupancy of a parking area during the selected time bins. For example, data processing component 414 may receive information from parking sensors 402 which identify the availability status of all parking spaces throughout the day. Data processing component 414 may note the average occupancy or maximum occupancy during each time bin based on the parking spot sensors. Alternatively, data processing component 414 may predict the capacity during time bins if parking spot sensor data is unavailable. For example, data processing component may determine the average occupancy based on historical data, or note that the average occupancy in the city is a particular percentage. That average percentage may be attributed to the present parking area to predict a likely occupancy for a time bin.

Calculation component 416 can use any of the above information to determine the frequency that the number of available spots was either equal to or below a threshold number of parking spots. If that frequency is less than a threshold percentage of cases, the system can determine that the threshold number can be rented as shared parking spaces in the time bin. If the frequency is higher than the threshold percentage, the threshold number may decrease as a higher percentage can indicate that it is more likely that there will be less spots actually available to use for parking. Once the appropriate threshold number is determined, calculation component 416 can set the threshold number as the determined number of parking spaces that can be rented out. In some embodiments, this determined number can be the maximum number of parking spaces.

Restriction component 418 can receive the determined number of parking spaces and determine a recommended number of spaces based on the determined number and data from pricing database 304B. Restriction component 418 can receive municipal data 408 and selected restrictions 410 from pricing database 304B to determine the recommended number. For example, municipal data 408 may comprise information that the city will incentivize shared parking spaces during a particular time or up to a maximum number of spaces (e.g. the city will compensate only up to 10 parking spaces during a particular time bin). Restrictions may also be dictated by owners of the parking garages e.g. data from selected restrictions 410. Restriction component 418 can reduce the determined number of parking spaces to the recommended number of spaces based on any restrictions.

Once the recommended number of parking spaces to rent is determined, determination and designation component 420 can determine what parking spaces to rent to the public and offer those spaces for public use. The determination may comprise designating a block of parking spaces close to an exit or entrance for the garage. If parking spot sensor data 402 is available, determination and designation component 420 can select specific parking spaces with a low occupancy rate to designate for the public. If one or more vehicles (e.g. vehicle 100) traverse the parking garage, the vehicles can receive image data on available parking spaces to determine which spaces are immediately available. Determination and designation component 420 can use any data from parking availability database 304A to select specific parking spaces. Alternatively, a parking garage owner can select parking spaces, which determination and designation component 420 can receive from selected restriction 410. As mentioned above, all components of memory 302B can receive data from parking availability database 304A or pricing database 304B. Determination and designation component 420 may update the selected parking spaces depending on the time bin, change in occupancy, or other factor associated with parking options. Determination and designation component can offer the selected parking spaces to non-tenants by transmitting information on the selected parking spaces to external databases or vehicles to be acknowledged by non-tenants.

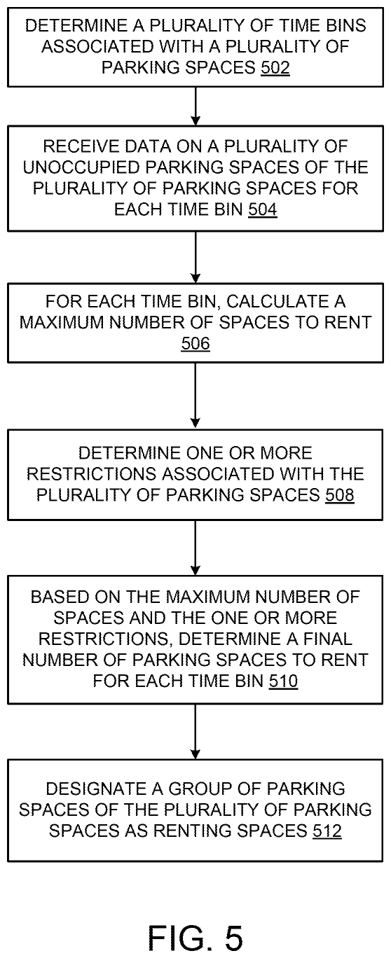

FIG. 5 illustrates an example method for determining parking spaces to rent to the public, in accordance with the embodiments described herein. At block 502, the system can determine a plurality of time bins associated with a plurality of reserved parking spaces (e.g. a parking garage or a parking lot). Reserved spaces may comprise parking spaces assigned to a particular tenant, a location of one or more parking spaces, or a group of parking spaces designated for tenant use. As described above, the time bins may comprise equal increments or may be divided based on portions of the day. Each time bin can be used to calculate a number of parking spaces to rent to the public during that specific time bin.

At block 504, the system can receive data on a plurality of unoccupied parking spaces of the plurality of parking spaces for each time bin. As described above, the data may comprise determinations from one or more vehicles that a parking space is available using image processing as described above. Other sources of data may comprise parking spot sensors, traffic/infrastructure data, and occupancy data. This data may be received from databases internal to the system or as part of an external server. The data may comprise information from parking sensors which identify the availability status of all parking spaces throughout the day. The system can note the average occupancy or maximum occupancy during each time bin based on the parking spot sensors. If real-time data is unavailable, the capacity may be predicted based on historical data. An average percentage may be attributed to the present parking area to predict a likely occupancy for a time bin.

At block 506, the system can calculate a determined number of spaces to rent for each time bin. In some embodiments, this determined number can be the maximum number of spaces that can be available to rent for a time bin. As described above, any of the above information can be used to determine the frequency that the number of available spots was either equal to or below a threshold number of parking spots. If that frequency is less than a threshold percentage of cases, the system can determine that the threshold number can be rented as shared parking spaces in the time bin. If the frequency is higher than the threshold percentage, the threshold number may decrease as a higher percentage can indicate that it is more likely that there will be less spots actually available to use for parking.

At block 508, the system can determine one or more restrictions associated with the plurality of parking spaces. As described above, the system can receive the determined number of parking spaces and determine a recommended number of spaces based on the determined number and restriction data such as municipal data and selected restrictions. This data can be used to determine a recommended number of parking spaces to rent. This data may include incentives based on city or state regulations, or may comprise selected restrictions from the owner of the parking lot or parking garage. The determined number of parking spaces can be reduced to a recommended number of parking spaces based on any restrictions. At block 510, the final number of parking spaces to rent for each time bin can be set based on the recommended number.

At block 512, the system can offer a group of parking spaces to non-tenants as renting spaces. As described above, the system can designate a block of parking spaces close to an exit or entrance for the garage. If parking spot sensor data is available, parking spaces can be selected based on parking spaces with a low occupancy rate. If one or more vehicles (e.g. vehicle 100) traverse the parking garage, the vehicles can receive image data on available parking spaces to determine which spaces are immediately available. Alternatively, a parking garage owner can select parking spaces. The designated parking spaces can be updated depending on the time bin, change in occupancy, or other factor associated with parking options.

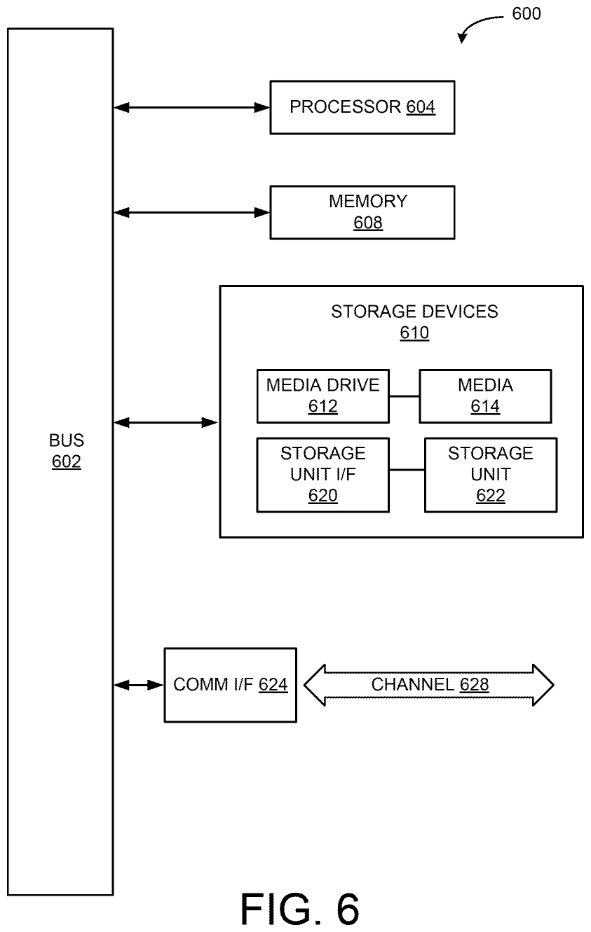

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 6. Various embodiments are described in terms of this example—computing component 600. After reading this description, it will become apparent to a person skilled in the relevant art how to implement the application using other computing components or architectures.

Referring now to FIG. 6, computing component 600 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 600 might also represent computing capabilities embedded within or otherwise available to a given device. For example, a computing component might be found in other electronic devices such as, for example, portable computing devices, and other electronic devices that might include some form of processing capability.

Computing component 600 might include, for example, one or more processors, controllers, control components, or other processing devices. Processor 604 might be implemented using a general-purpose or special-purpose processing engine such as, for example, a microprocessor, controller, or other control logic. Processor 604 may be connected to a bus 602. However, any communication medium can be used to facilitate interaction with other components of computing component 600 or to communicate externally.

Computing component 600 might also include one or more memory components, simply referred to herein as main memory 608. For example, random access memory (RAM) or other dynamic memory, might be used for storing information and instructions to be executed by processor 604. Main memory 608 might also be used for storing temporary variables or other intermediate information during execution of instructions to be executed by processor 604. Computing component 600 might likewise include a read only memory (“ROM”) or other static storage device coupled to bus 602 for storing static information and instructions for processor 604.

The computing component 600 might also include one or more various forms of information storage mechanism 610, which might include, for example, a media drive 612 and a storage unit interface 620. The media drive 612 might include a drive or other mechanism to support fixed or removable storage media 614. For example, a hard disk drive, a solid-state drive, a magnetic tape drive, an optical drive, a compact disc (CD) or digital video disc (DVD) drive (R or RW), or other removable or fixed media drive might be provided. Storage media 614 might include, for example, a hard disk, an integrated circuit assembly, magnetic tape, cartridge, optical disk, a CD or DVD. Storage media 614 may be any other fixed or removable medium that is read by, written to or accessed by media drive 612. As these examples illustrate, the storage media 614 can include a computer usable storage medium having stored therein computer software or data.

In alternative embodiments, information storage mechanism 610 might include other similar instrumentalities for allowing computer programs or other instructions or data to be loaded into computing component 600. Such instrumentalities might include, for example, a fixed or removable storage unit 622 and an interface 620. Examples of such storage units 622 and interfaces 620 can include a program cartridge and cartridge interface, a removable memory (for example, a flash memory or other removable memory component) and memory slot. Other examples may include a PCMCIA slot and card, and other fixed or removable storage units 622 and interfaces 620 that allow software and data to be transferred from storage unit 622 to computing component 600.

Computing component 600 might also include a communications interface 624. Communications interface 624 might be used to allow software and data to be transferred between computing component 600 and external devices. Examples of communications interface 624 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 624 may be carried on signals, which can be electronic, electromagnetic (which includes optical) or other signals capable of being exchanged by a given communications interface 624. These signals might be provided to communications interface 624 via a channel 628. Channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 608, storage unit 620, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 600 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method comprising:
determining a time bin associated with a plurality of reserved parking spaces of a parking garage;
receiving sensor data from one or more sensors collecting information about parking spaces in the garage, and processing the sensor data to determine a quantity of unoccupied parking spaces of the plurality of reserved parking spaces for the time bin;
calculating a percentage of time duration for which the determined quantity of open parking spaces is lower than a first threshold;
comparing the percentage of time duration to a second threshold;
if the percentage of time duration is less than the second threshold, determining that the first threshold of open parking spaces may be rented to non-tenants;
determining one or more restrictions associated with the plurality of reserved parking spaces;
based on the first threshold of open parking spaces and the one or more restrictions, determining a final number of parking spaces to offer for rent for each time bin; and
offering a group of parking spaces to non-tenants.

2. The method of claim 1, wherein the sensor data comprises at least one of image data, parking spot sensor data, vehicle sensor data, and infrastructure sensor data.

3. (canceled)

4. The method of claim 1, further comprising decreasing the first threshold if the percentage of time duration is higher than the second threshold.

5. The method of claim 1, further comprising increasing the first threshold if the percentage of time duration is lower than the second threshold.

6. The method of claim 1, wherein the one or more restrictions comprises at least one of municipal parking restrictions and selected parking restrictions.

7. The method of claim 1, wherein offering the group of parking spaces comprises selecting a subset plurality of parking spaces close to an exit or entrance.

8. The method of claim 1, wherein offering the group of parking spaces comprises selecting a subset plurality of parking spaces with an occupancy rate below an occupancy threshold.

9. The method of claim 1, further comprising displaying information on the spaces offered for rent in a vehicle within a threshold distance of the plurality of parking spaces.

10. The method of claim 9, wherein the vehicle within a threshold distance of the plurality of parking spaces communicates the information to one or more additional vehicles through a vehicle-connected network.

11. The method of claim 1, further comprising transmitting information on the spaces offered for rent to an external database.

12. The method of claim 1, wherein determining a plurality of time bins comprises receiving occupancy data on the plurality of parking spaces for a plurality of time periods and determining time bins by grouping time periods with similar occupancy data.

13. The method of claim 1, wherein determining a plurality of time bins is based on operating hours for one or more organizations associated with the plurality of parking spaces.

14. The method of claim 1, wherein calculating a determined number of the reserved spaces to offer for rent is based on renting the reserved spaces for one or more successive time bins.

15. A system, comprising:
a processor; and
a memory coupled to the processor to store instructions, which when executed by the processor, cause the processor to:
determine a time bin associated with a plurality of parking spaces of a parking garage;
receiving sensor data from one or more sensors collecting information about parking spaces in the garage, and processing the sensor data to determine a quantity of unoccupied parking spaces of the plurality of parking spaces for the time bin;
calculate a percentage of time duration for which the quantity of unoccupied parking spaces is lower than a first threshold;
compare the percentage of time duration to a second threshold;
if the percentage of time duration is less than the second threshold, determining that the first threshold of open parking spaces may be rented to non-tenants;
determine one or more restrictions associated with the plurality of parking spaces;
based on the first threshold of open parking spaces and the one or more restrictions, determine a final number of parking spaces to rent for the time bin; and
designate a group of parking spaces of the plurality of parking spaces as renting spaces.

16. The system of claim 15, wherein the sensor data comprises at least one of vehicle image data infrastructure data, and occupancy data.

17. The system of claim 15, wherein the processor is further configured to decrease the first threshold if the percentage of time duration is higher than the second threshold.

18. The system of claim 17, wherein the processor is further configured to repeat all steps until the percentage of time duration is less than the second threshold.

19. The system of claim 15, wherein the one or more restrictions comprises at least one of municipal parking restrictions and selected parking restrictions.

20. The system of claim 15, wherein the processor is further configured to select a subset plurality of parking spaces close to an exit or entrance as renting spaces.

21. The system of claim 15, wherein designating the group of parking spaces of the plurality of parking spaces as renting spaces is based on renting the designated renting spaces for one or more successive time bins.
